(19) United States
(12) Patent Application Publication
(10) Pub. No.: US 2007/0155400 A1
(43) Pub. Date: Jul. 5, 2007

(54) Method, apparatus and computer program product for determining location of a mobile terminal

(75) Inventor: Jens Ole Madsen, Frederiksberg C (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/322,916

(22) Filed: Dec. 30, 2005

(51) Int. Cl. H04Q 7/20

(52) U.S. Cl. 455/456.1; 455/551

(57) ABSTRACT

A method of determining a location of a mobile terminal using a user identity module (UIM) includes issuing an instruction from the UIM to the mobile terminal instructing the mobile terminal to perform a positioning event and receiving position data from the mobile terminal responsive to the positioning event.

### FIELD OF THE INVENTION

Embodiments of the present invention relate generally to mobile terminal technology and, more particularly, relate to a method, apparatus, and computer program product for providing location information associated with a mobile terminal.

### BACKGROUND OF THE INVENTION

In many wireless communication networks and other mobile networks, the network keeps track of the location of mobile terminals, such as mobile telephones, at least on a cell level. In such networks, it is typically also possible to determine the geographic location of the mobile terminals, and provide services based upon the location of the mobile terminals. For example, IN-based solutions have been implemented, triggering certain Intelligent Network (IN) functionality, such as call forwarding or call barring, based on the location of a mobile terminal, and thus the mobile subscriber. Also in current systems implementing the Global System for Mobile Communications (GSM) standard, local Short Messaging Service (SMS) messages can be provided based on the current location of a subscribing mobile terminal.

In various applications, service announcements can be transmitted to mobile terminals on the basis of a service request of a subscriber in a mobile communication system. Generally, the provision of these chargeable services is most often arranged from outside the actual mobile communication system. By making a call to a required service number or sending a request over the Internet, for example, a mobile subscriber is able to order a selected service announcement to be delivered to the mobile terminal, such as via the display of the mobile terminal. Of these individual services, e.g., weather forecast, traffic announcements, local news and other local services, such as taxi ordering, service station announcements and so on, are services where the mobile subscriber selects the desired announcement on the basis of the geographic area. The mobile subscriber generally wishes to have the service announcement related to his/her current location which varies because of the mobile nature of the mobile subscriber.

Due to a dependency of many location based services upon the current location of the mobile terminal, network operators may require access to information about the current location of the mobile terminal. A card application toolkit is currently in use in many mobile terminals. The card application toolkit is an application program interface (API) implemented in the mobile terminal, which may be used to provide location based services based on the location of the mobile terminal. Current card application toolkits use techniques of determining mobile terminal location which include, for example, a cell identification (ID) method and a network measurement results method. In the cell ID method, the card application toolkit includes an application that may require local information from the mobile terminal. The local information includes operator information and a current cell location of the mobile terminal. Based on this local information, the cell ID method can generally determine the location of the mobile terminal. The network measurement results method takes into account information about signal strength from neighboring cells, thereby permitting a form of triangulation to determine a current location of the mobile terminal. Both the cell ID and the network measurement results provide somewhat limited accuracy. Additionally, both the cell ID and the network measurement results methods utilize information that has previously been stored by the mobile terminal and which may be outdated, thereby leading to a determination not of the current location of the mobile terminal, but the general location of the mobile terminal at some prior point in time.

More accurate means of obtaining accurate information about a current location of a mobile terminal are becoming more widely available for use on mobile terminals. Examples of more accurate means include GPS, Assisted-GPS, etc. However, network operators currently have no means to initiate access to this, more accurate location information. Additionally, even if the network operators could access the location information, the network operators could only access location information already present in the mobile terminal.

### BRIEF SUMMARY OF THE INVENTION

A method, apparatus and computer program product are therefore provided that uses a command stored on a user identity module (UIM), which may be used to open an application in a card application toolkit to send mobile terminal location information to the UIM. The card application toolkit may allow the UIM to access and utilize mobile terminal resources to determine location of the mobile terminal, or direct the mobile terminal to conduct a positioning event with a network. Thus, network operators will possess a means to activate positioning resources and receive data including the location of the mobile terminal via the UIM.

In one exemplary embodiment, a method of determining a location of a mobile terminal using a user identity module (UIM) includes issuing an instruction from the UIM to the mobile terminal instructing the mobile terminal to perform a positioning event and receiving position data from the mobile terminal responsive to the positioning event.

In another exemplary embodiment, a method of determining a location of a mobile terminal is provided. The method includes receiving an instruction to perform a positioning event from a user identity module (UIM), performing the positioning event, and providing position data to the UIM. The position data is responsive to the positioning event.

In another exemplary embodiment, a computer program product for determining a location of a mobile terminal is provided. The computer program product includes a storage medium, readable by a processing circuit, storing instructions for execution by the processing circuit. The instructions are for issuing an instruction from a user identity module (UIM) to the mobile terminal instructing the mobile terminal to perform a positioning event, and receiving position data at the UIM from the mobile terminal responsive to the positioning event.

In another exemplary embodiment, a computer program product for determining a location of a mobile terminal is provided. The computer program product includes a storage medium, readable by a processing circuit, storing instructions for execution by the processing circuit. The instructions are for receiving an instruction to perform a positioning event from a user identity module (UIM), performing the positioning event, and providing position data to the UIM responsive to the positioning event.

In another exemplary embodiment, a user identity module (UIM) for use with a mobile terminal is provided. The UIM includes a processor for determining a location of a mobile terminal. The processor is configured to provide an instruction to the mobile terminal to perform a positioning event, and receive a position data from the mobile terminal. The position data is responsive to the positioning event.

In another exemplary embodiment, a mobile terminal having a processor for determining a location of the mobile terminal is provided. The processor is configured to receive an instruction to perform a positioning event from a user identity module (UIM), perform the positioning event, and provide the position data to the UIM responsive to the positioning event.

Embodiments of the invention provide a method, apparatus and computer program product for determining a position of a mobile terminal. As a result, network operators may be given access to mobile terminal position data, which may, for example, influence those services available to the mobile terminal.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention including a cellular network and a data network to which a mobile terminal is bi-directionally coupled;

FIG. 3 illustrates a control flow diagram according to an exemplary method of determining a location of a mobile terminal;

FIG. 4 illustrates a control flow diagram according to another exemplary method of determining a location of a mobile terminal;

FIG. 5 illustrates a control flow diagram according to another exemplary method of determining a location of a mobile terminal;

FIG. 6 illustrates a control flow diagram according to another exemplary method of determining a location of a mobile terminal; and

FIG. 7 illustrates a control flow diagram according to another exemplary method of determining a location of a mobile terminal.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

An embodiment of the invention may be embodied in the form of computer-implemented processes and apparatuses for practicing those processes. The present invention may also be embodied in the form of computer program product containing instructions stored in tangible media, such as floppy diskettes, CD-ROMs, hard drives, or any other computer readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. The technical effect of the executable instructions is to determine a current position of a mobile terminal responsive to an instruction from a user identity module (UIM).

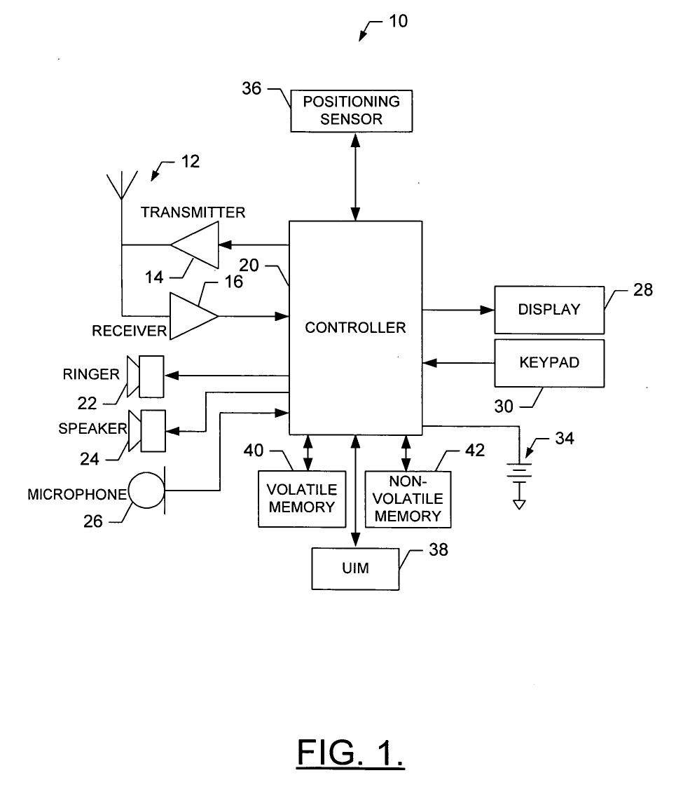

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, laptop computers and other types of voice and text communications systems, can readily employ the present invention. Moreover, the method of the present invention will be primarily described in conjunction with mobile communications applications. But the method of the present invention can be utilized in conjunction with a variety of other applications, both in the mobile communications industries and outside of the mobile communications industries.

In addition, while several embodiments of the present invention include a mobile terminal 10, the terminal need not be mobile. Similarly, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 of the illustrated embodiment includes an antenna 12 in operable communication with a transmitter 14 and a receiver 16. The mobile terminal 10 further includes a processing element, such as a controller 20 that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus also includes the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example. Also, for example, the controller 20 may be capable of operating a software application capable of authorizing the delivery of location information regarding the mobile terminal, in accordance with embodiments of the present invention (described below).

The mobile terminal 10 also comprises a user interface including a conventional earphone or speaker 22, a ringer 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10.

The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. In this regard, the positioning sensor 36 is capable of determining a location of the mobile terminal 10, such as, for example, the longitudinal and latitudinal coordinates of the current location of the mobile terminal 10.

The mobile terminal 10 may be equipped with or otherwise be adapted to receive a UIM 38. The UIM 38 is typically a memory device having a processor built in. The UIM 38 may include, for example, a subscriber identity module (SIM), a universal integrated circuit card (IUCC), a universal subscriber identity module (USIM), a removable user identity module (R-UIM), etc. The UIM 38 typically stores information elements related to a mobile subscriber. In addition to the UIM 38, the mobile terminal 10 may be equipped with other memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal to implement the functions of the mobile terminal. For example, the memories can include an identifier, such as an international mobile equipment identification (IMEI) code, capable of uniquely identifying the mobile terminal 10.

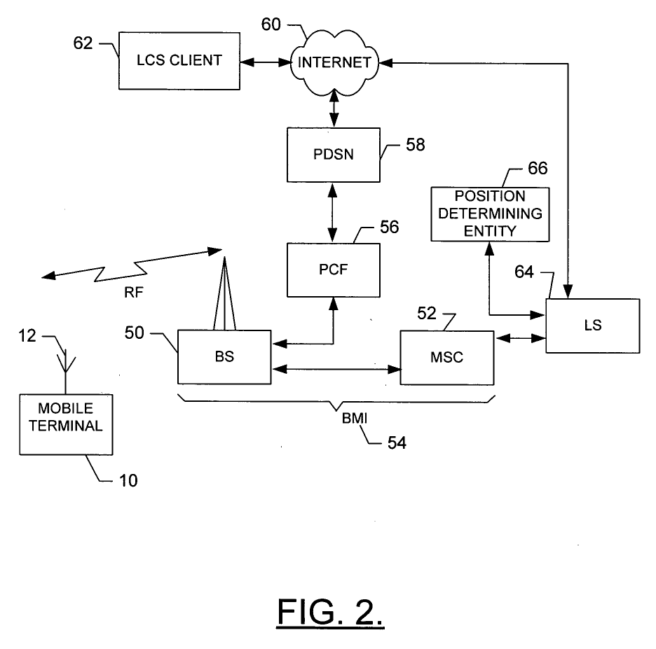

Referring now to FIG. 2, an illustration of one type of wireless communications network including a terminal, such as the mobile terminal 10, which would benefit from embodiments of the present invention is provided. As shown, the mobile terminal 10 includes the antenna 12 for transmitting signals to and for receiving signals from a base site or base station (BS) 50. The BS 50 is a part of a cellular network that includes a mobile switching center (MSC) 52, voice coder/decoders (vocoders), data modems, and other units required to operate the cellular network. The MSC 52 is capable of routing calls and messages to and from the mobile terminal 10 when the mobile terminal 10 is making and receiving calls. The cellular network may also be referred to as a Base Station/MSC/Interworking function (BMI) 54. The MSC 52 controls the forwarding of messages to and from the mobile terminal 10 when the mobile terminal 10 is registered with the cellular network, and also controls the forwarding of messages for the mobile terminal 10 to and from a message center (not shown). Such messages may include, for example, voice messages received by the MSC 52 from users of Public Switched Telephone Network (PSTN) telephones, and may also include Short Message Service (SMS) messages and voice messages received by the MSC 52 from the mobile terminal 10 or other mobile terminals serviced by the cellular network.

The mobile terminal 10 can also be coupled to a data network. For example, the BS 50 can be connected to a packet control function (PCF) 56, which is in communication with a Packet Data Serving Node (PDSN) 58. The PDSN 58 may be connected to a wide area network, such as the Internet 60. In turn, devices such as processing elements (e.g., personal computers, server computers or the like) can be coupled to the mobile terminal 10 via the PDSN 58. For example, the processing elements can include one or more processing elements associated with a location services (LCS) client 62. By directly or indirectly connecting both the mobile terminal 10 and the other devices to the PDSN 58 and the Internet 60, the mobile terminal 10 can communicate with the other devices, such as according to the Internet Protocol (IP) specification, to thereby carry out various functions of the mobile terminal 10.

The MSC 52 is coupled to a location server (LS) 64 providing location services for different applications or LCS clients 62 (only one client shown for clarity). In general terms, the LS 64 can be defined as an entity capable of providing information concerning a geographical location of the mobile terminal 10. In this regard, the LS 64 may be coupled to a position determining entity 66 capable of determining the geographic location provided by the LS 64. The geographical location may be defined on the basis of the position of the mobile terminal 10 relative to the base station 50 of the wireless communications network.

The geographical location of the base station 50 and/or the mobile terminal 10 may be defined, for example, in X and Y coordinates or in latitudes and longitudes. The geographical location may be in other manners. For example, the geographical location may alternatively be defined in a spherical coordinate system utilizing defined radiuses and angles. In addition to a geographical location in an X-Y plane, the location of the base stations and/or mobile terminals may also be defined in a vertical direction. For example, a Z coordinate may be used when providing the location information in the vertical direction. The vertical location may be advantageous in some situations such as to define the location in mountainous environments or in cities with tall buildings.

The LS 64 can comprise any of a number of known elements in the wireless communications network such as, for example, a gateway mobile location center (GMLC), as defined by the GSM specification. The LS 64 is typically arranged to receive a request for location information, such as from an LCS client 62. If the LCS client 62 is authorized to receive the location information, then, the LS 64 can initiate determining the location of the mobile terminal 10, such as by the position determining entity 66. In this regard, in response to an initiation signal from the LS 64, the position determining entity 66 is adapted to collect predefined information concerning the location of the mobile terminal 10. The position determining entity 66 is also adapted to process the information, if necessary, in order to determine the geographical location of the mobile terminal 10. It should be appreciated that location information obtained by the LS 64 and provided to the LCS client 62 in accordance with a conventional technique is location information stored at the mobile terminal 10 and provided in response to user authorized requests initiated via the LCS client 62. In these conventional techniques, accuracy of the location information and time of determining the location information are not included with the location information provided to the LS 64. Moreover, the location information provided by the mobile terminal 10 may be somewhat outdated since the mobile terminal 10 may have moved since the location information was last captured. As will be shown below, embodiments of the present invention remedy a number of these deficiencies and provide additional advantages.

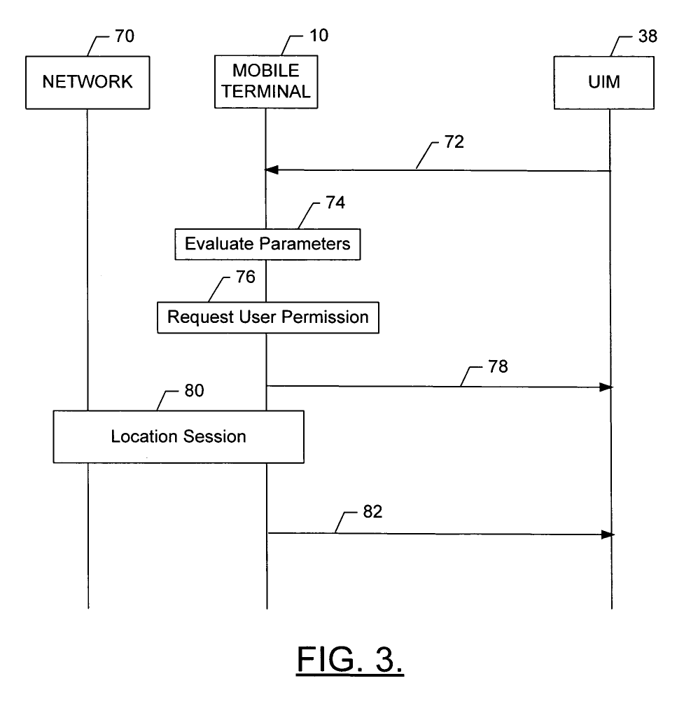

As previously indicated, conventional mobile networks are configured such that a network operator may not initiate a request for the location of a mobile terminal 10. Instead, the network operator must have consent from the mobile terminal 10, or more particularly a user of the mobile terminal 10, to provide the location of the mobile terminal 10. Embodiments of the present invention are not so limited and permit updated location information to be requested and obtained by a network operator or other network entity. For example, one embodiment of the present invention provides an additional card application toolkit command, which may be initiated by the UIM 38, to cause an additional card application toolkit event to be performed by the mobile terminal 10 that is designed to enable the mobile terminal 10 to provide updated location information. The additional commands and events that are effectuated by several embodiments of the present invention will be described below with reference to FIGS. 3-7. It should be noted that the present invention may be embodied in many different manner. In that regard, FIGS. 3-7 illustrate several exemplary embodiments for purposes of illustration and not limitation.

FIG. 3 illustrates a control flow diagram according to an exemplary method of determining a location of a mobile terminal 10. As shown in FIG. 3, the UIM 38 initiates a positioning event at the mobile terminal 10, by sending an instruction 72 to the mobile terminal 10. The positioning event may be initiated responsive to the network operator sending a message to initiate the positioning event. The positioning event includes a determination of the current location of the mobile terminal 10 via a location session 80 and the subsequent provision of the position data 82 to the UIM 38. The instruction 72 directs the mobile terminal 10 to perform the positioning event and may include a command name such as SET UP POSITIONING. The instruction 72 is typically a card application toolkit command which the UIM 38 is configured to send to the mobile terminal 10 and, in part, the controller 20 of the mobile terminal 10, in response to network operator input that requests location information, such as from a position determining entity. The instruction 72 may include requested location parameter data which provide the mobile terminal 10 with specific location parameters to limit or guide the mobile terminal 10 in performance of the instruction. The mobile terminal 10 performs an evaluation of the requested location parameter data at 74.

The requested location parameter data may include, for example, a requested quality of position (QoP) in the location determination, a requested number of fixes, a requested time between fixes, etc. The QoP may provide the mobile terminal 10 with a desired accuracy for a result of the positioning event. The mobile terminal 10 then chooses a selected position determining technique or protocol from among those available in the mobile network in which the mobile terminal 10 is located. Alternatively, if the mobile terminal 10 is equipped with protocol that operates independently of the mobile network, such protocol may also be chosen. The selected protocol may be, for example, 3GPP2 XP0024, OMA SUPL 1.0, gpsOne v1, gpsOne v2, etc., with different ones of the protocols capable of providing location information with different accuracies. Thus the protocol may be selected to provide the desired accuracy. The number of fixes specifies a number of positioning events to be performed. In response to the number of fixes being zero, the mobile terminal 10 will stop a location session already in progress. Alternatively, the UIM 38 may request a continuous stream of fixes to allow the mobile terminal 10 to be tracked. The time between fixes specifies a selected amount of time between each of the fixes.

The mobile terminal 10 may optionally request user permission at 76. Such request may depend on user security settings. For example, the user may select a security setting which always grants permission, never grants permission or prompts the user to grant permission each time a positioning event is requested.

After the mobile terminal 10 performs an evaluation of the requested location parameter data at 74, the mobile terminal 10 provides a terminal response 78 to the UIM 38. The terminal response 78, may include, for example, an error message or a status message. The error message is generated, for example, in response to the mobile terminal 10 being unable to provide the requested QoP, the mobile terminal 10 being out of service, the mobile terminal 10 being unable to support multiple fixes, or the mobile terminal otherwise being unable to provide the requested location information. The status message may include, for example, a COMMAND PERFORMED SUCCESSFULLY response, which indicates that the mobile terminal 10 will perform the positioning event.

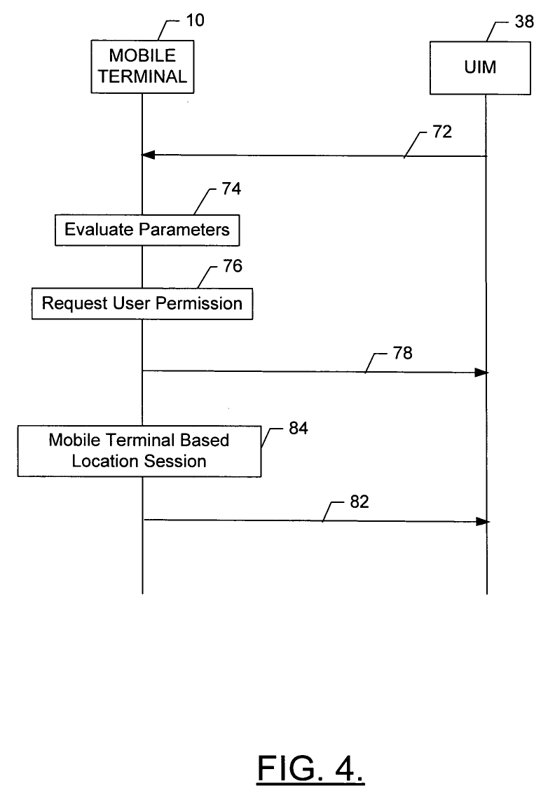

Responsive to commencement of the positioning event which occurs concurrent with or following the transmission of the status message, a location session 80 may be conducted with a network 70. Alternatively, the location session 80 may be conducted independent of the network 70 (see FIG. 4). The location session 80 includes use of a selected position determining technique or protocol, which may be one of those described above, to determine the location of the mobile terminal 10. To complete the positioning event, position data 82 is sent from the mobile terminal 10 to the UIM 38. The position data 82 includes, for example, data including the location of the mobile terminal 10, data including time since the location of the mobile terminal 10 was determined (or the time at which the location was determined), a status message, etc. In one embodiment, the position data 82 may be sent to the UIM 38 with a POSITIONING EVENT message. In instances in which the positioning event was terminated prematurely, the status message may include, for example, a reason for termination of the positioning event instead of the requested location information. Once the UIM 38 has the position data 82, the position data 82 may be relayed to, for example, a network entity requesting mobile terminal 10 location information.

FIG. 4 illustrates a control flow diagram according to another exemplary method of determining a location of a mobile terminal 10 independent of a network. Referring now to FIG. 4, a UIM 38 sends an instruction 72 to the mobile terminal 10, and, in particular, to the controller 20 of the mobile terminal 10, directing the mobile terminal 10 to perform the positioning event. As stated above, the instruction 72 may be responsive to a request for location information by a network operator or other network entity. The instruction 72, for example, includes requested location parameter data, which is evaluated at 74. The mobile terminal 10 optionally requests user permission at 76 responsive to security settings. At optional operation 76, the requested location parameter data may be checked to ensure the requested location parameter data can be provided. A terminal response 78 is sent from the mobile terminal 10 to the UIM 38. If the mobile terminal 10 determines that the location can be determined, the mobile terminal 10 conducts a mobile terminal based location session 84 in accordance with the location parameter data independent of the network, and provides position data 82 to the UIM 38 to complete the positioning event. Once the UIM 38 has the position data 82, the position data 82 may be relayed to, for example, a network entity requesting mobile terminal 10 location information.

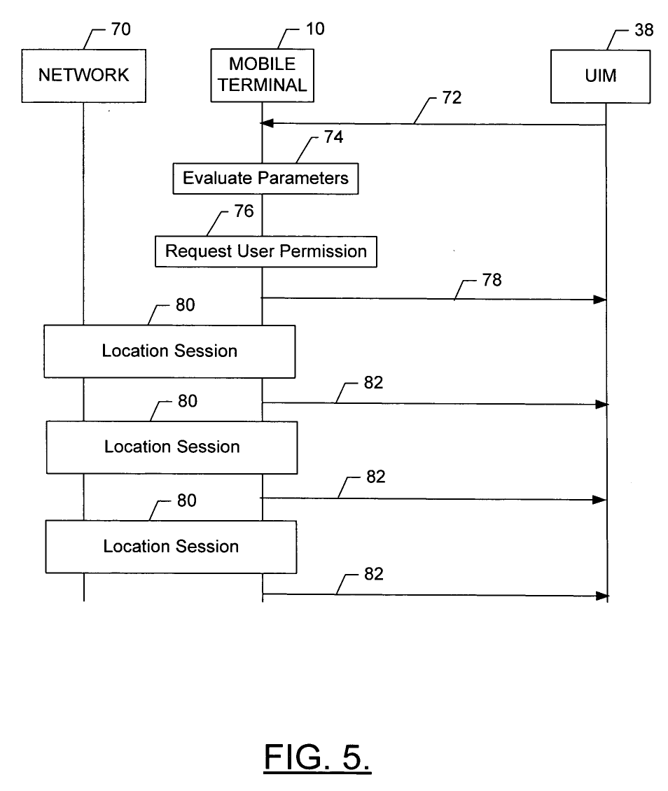

FIG. 5 illustrates a control flow diagram according to another exemplary method of determining a location of a mobile terminal 10 in which a selected number of fixes is requested by, for example, a network entity or a network operator. Referring now to FIG. 5, a UIM 38 sends an instruction 72 to the mobile terminal 10, directing the mobile terminal 10 to perform the positioning event. As stated above, the instruction 72 may be responsive to a request for location information by a network operator or other network entity. The instruction 72 includes requested location parameter data including a requested number of fixes equal to three, which is evaluated at 74. The mobile terminal 10 optionally requests user permission at 76 responsive to security settings. At optional operation 76, the requested location parameter data may be checked to ensure the requested location parameter data can be provided. If the mobile terminal 10 determines that the location can be determined, a TERMINAL RESPONSE message 78 is sent from the mobile terminal 10 to the UIM 38. The mobile terminal 10 conducts a location session 80 with a network 70 and provides position data 82 to the UIM 38 to complete a first positioning event. The mobile terminal 10 then conducts another location session 80 and provides corresponding position data 82 to complete a second positioning event. Finally, the mobile terminal 10 conducts another location session 80 and provides corresponding position data 82 to complete a third positioning event. After determining the location the number of times predefined by the requested number of fixes, the positioning event is complete. Once the UIM 38 has the position data 82, the position data 82 may be relayed to, for example, a network entity requesting mobile terminal 10 location information.

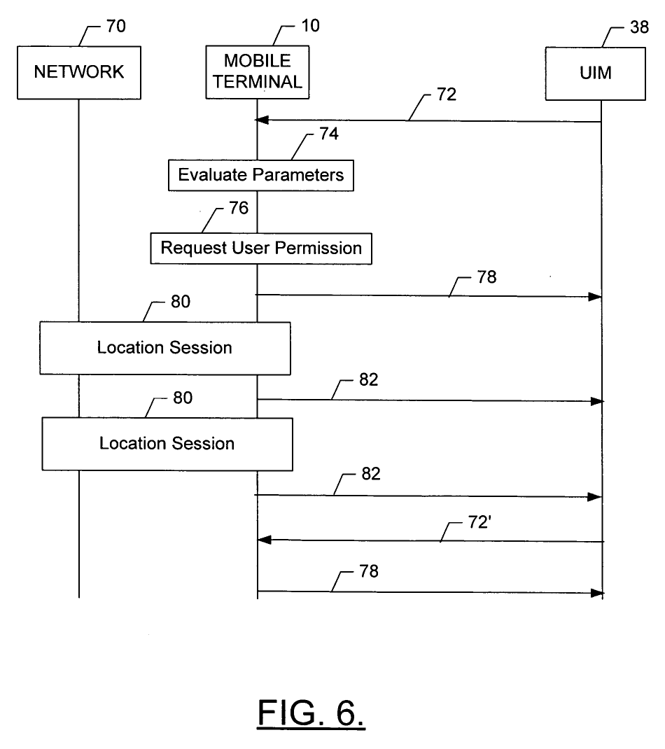

FIG. 6 illustrates a control flow diagram according to another exemplary method of determining a location of a mobile terminal 10 in which a periodic tracking is interrupted by a command from a UIM 38. Referring now to FIG. 6, the UIM 38 sends an instruction 72 to the mobile terminal 10, directing the mobile terminal 10 to perform the positioning event. As stated above, the instruction 72 may be responsive to a request for location information by a network operator or other network entity. The instruction 72 includes requested location parameter data including a requested number of fixes greater than or equal to three, which is evaluated at 74. The mobile terminal 10 optionally requests user permission at 76 responsive to security settings. At optional operation 76, the requested location parameter data may be checked to ensure the requested location parameter data can be provided. If the mobile terminal 10 determines that the location can be determined, a TERMINAL RESPONSE message 78 is sent from the mobile terminal 10 to the UIM 38. The mobile terminal 10 conducts a location session 80 with a network 70 and provides position data 82 to the UIM 38 to complete a first positioning event. The mobile terminal 10 then conducts another location session 80 and provides corresponding position data 82 to complete a second positioning event. Then, the UIM 38 sends a stop instruction 72′, which stops the periodic tracking by sending a requested number of fixes equal to zero. Finally, the mobile terminal 10 sends a TERMINAL RESPONSE message 78 indicating COMMAND PERFORMED SUCCESSFULLY. Once the UIM 38 has the position data 82, the position data 82 may be relayed to, for example, a network entity requesting mobile terminal 10 location information.

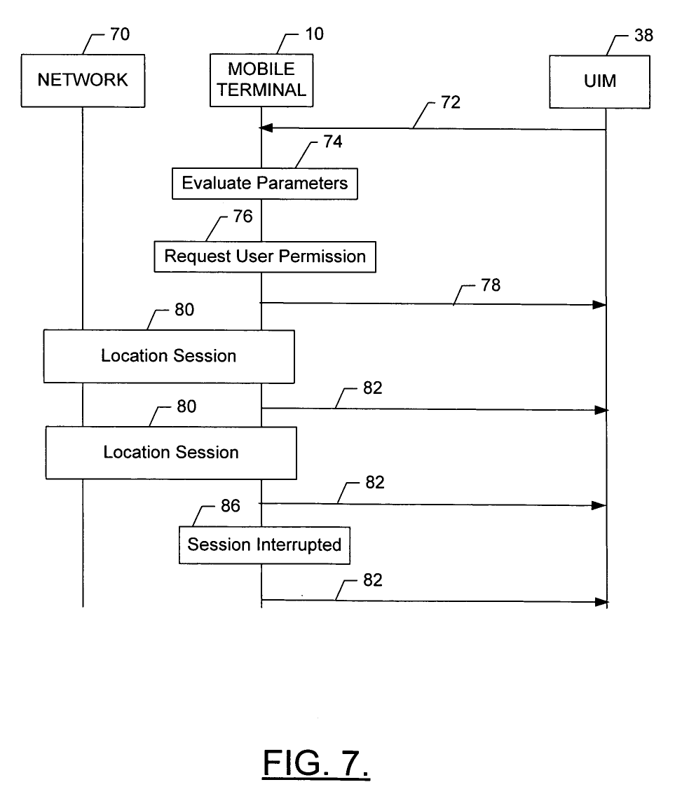

FIG. 7 illustrates a control flow diagram according to another exemplary method of determining a location of a mobile terminal 10 in which a periodic tracking is stopped by a session interruption 86. Referring now to FIG. 7, a UIM 38 sends an instruction 72 to the mobile terminal 10, directing the mobile terminal 10 to perform the positioning event. As stated above, the instruction 72 may be responsive to a request for location information by a network operator or other network entity. The instruction 72 includes requested location parameter data including a requested number of fixes greater than or equal to three, which is evaluated at 74. The mobile terminal 10 optionally requests user permission at 76 responsive to security settings. At optional operation 76, the requested location parameter data may be checked to ensure the requested location parameter data can be provided. If the mobile terminal 10 determines that the location can be determined, a TERMINAL RESPONSE message 78 is sent from the mobile terminal 10 to the UIM 38. The mobile terminal 10 then conducts a location session 80 with a network 70 and provides position data 82 to the UIM 38 to complete a first positioning event. The mobile terminal 10 then conducts another location session 80 and provides corresponding position data 82 to complete a second positioning event. Responsive to the session interruption 86, the periodic tracking is stopped. Thus, the mobile terminal 10 sends a TERMINAL RESPONSE message 78 including a status message and a reason for terminating the positioning event. The session interruption 86 may include, for example, a loss of a data link between the mobile terminal 10 and the network 70, loss of GPS coverage, user interruption, etc.

According to one aspect of the invention, all or a portion of the system of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Accordingly, the present invention provides a mechanism by which a network entity or network operator may initiate a positioning event by sending a request to a UIM 38 of a mobile terminal 10. In response to the request, the mobile terminal 10 conducts a positioning event with a network 70 and may supply location information describing the position of the mobile terminal 10 to the network entity or network operator.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of determining a location of a mobile terminal using a user identity module (UIM), the method comprising:
issuing an instruction from the UIM to the mobile terminal instructing the mobile terminal to perform a positioning event; and
receiving position data at the UIM from the mobile terminal responsive to the positioning event.

2. A method according to claim 1 further comprising receiving a terminal response from the mobile terminal.

3. A method according to claim 2, wherein the receiving the terminal response comprises at least one of:
receiving an error message; and
receiving a status of the positioning event.

4. A method according to claim 1, wherein issuing an instruction comprises defining parameters for the positioning event.

5. A method according to claim 4, wherein defining parameters comprises at least one of:
specifying a number of fixes;
specifying a time between the fixes; and
requesting a selected quality of position.

6. A method according to claim 1, wherein receiving the position data comprises at least one of:
receiving data including the location of the mobile terminal;
receiving data including time since the location of the mobile terminal was determined; and
receiving a status message including a reason for termination of the positioning event.

7. A method of determining a location of a mobile terminal, the method comprising:
receiving an instruction to perform a positioning event from a user identity module (UIM);
performing the positioning event; and
providing position data to the UIM, the position data being responsive to the positioning event.

8. A method according to claim 7, wherein receiving the instruction further comprises evaluating parameters for the positioning event.

9. A method according to claim 8, wherein evaluating parameters comprises at least one of:
evaluating a requested number of fixes;
evaluating a requested time between the fixes; and
evaluating a requested quality of position.

10. A method according to claim 7, further comprising responding to the instruction by providing at least one of:
requesting user permission to perform the positioning event; and
providing a status of the positioning event.

11. A method according to claim 7, wherein providing position data to the UIM comprises at least one of:
providing data including the location of the mobile terminal;
providing data including time since the location of the mobile terminal was determined; and
providing a status message including a reason for termination of the positioning event.

12. A method according to claim 7, wherein performing the positioning event comprises obtaining data including the location of the mobile terminal in response to the mobile terminal conducting a location session with a network.

13. A method according to claim 7, wherein performing the positioning event comprises obtaining data including the location of the mobile terminal independent of a network.

14. A computer program product for determining a location of a mobile terminal, the product comprising:
a storage medium, readable by a processing circuit, storing instructions for execution by the processing circuit for:
issuing an instruction from a user identity module (UIM) to the mobile terminal instructing the mobile terminal to perform a positioning event; and
receiving position data at the UIM from the mobile terminal responsive to the positioning event.

15. A computer program product according to claim 14, wherein issuing an instruction comprises defining parameters for the positioning event.

16. A computer program product according to claim 15, wherein the parameters comprise at least one of:
a specified number of fixes;
a specified time between the fixes; and
a selected quality of position.

17. A computer program product according to claim 14, wherein the position data comprises at least one of:
data including the location of the mobile terminal;
a time since the location of the mobile terminal was computed; and
a status message including a reason for termination of the positioning event.

18. A computer program product according to claim 14, wherein the processing circuit is disposed in the UIM.

19. A computer program product for determining a location of a mobile terminal, the product comprising:
a storage medium, readable by a processing circuit, storing instructions for execution by the processing circuit for:
receiving an instruction to perform a positioning event from a user identity module (UIM);
performing the positioning event; and
providing position data to the UIM responsive to the positioning event.

20. A computer program product according to claim 19, wherein receiving the instruction further comprises evaluating parameters for the positioning event.

21. A computer program product according to claim 20, wherein evaluating parameters comprises at least one of:
evaluating a requested number of fixes;
evaluating a requested time between the fixes; and
evaluating a requested quality of position.

22. A computer program product according to claim 19, wherein the position data comprises at least one of:
a determination of the location of the mobile terminal;
a time since the location of the mobile terminal was determined; and
a status message including a reason for termination of the positioning event.

23. A computer program product according to claim 19, wherein performing the positioning event comprises obtaining the position data in response to the mobile terminal conducting a location session with a network.

24. A computer program product according to claim 19, wherein performing the positioning event comprises obtaining the position data independent of a network.

25. A user identity module (UIM) for use with a mobile terminal, the UIM having a processor for determining a location of a mobile terminal, the processor configured to:
provide an instruction to the mobile terminal to perform a positioning event; and
receive a position data from the mobile terminal, the position data being responsive to the positioning event.

26. A UIM according to claim 25, wherein the instruction to the mobile terminal comprises parameters for the positioning event.

27. A UIM according to claim 26, wherein the parameters comprise at least one of:
a specified number of fixes;
a specified time between the fixes; and
a selected quality of position.

28. A UIM according to claim 25, wherein the position data comprises at least one of:
data including the location of the mobile terminal;
a time since the location of the mobile terminal was computed; and
a status message including a reason for termination of the positioning event.

29. A mobile terminal having a processor for determining a location of the mobile terminal, the processor configured to:
receive an instruction to perform a positioning event from a user identity module (UIM);
perform the positioning event; and
provide the position data to the UIM responsive to the positioning event.

30. A mobile terminal according to claim 29, wherein the instruction comprises a parameter for the positioning event.

31. A mobile terminal according to claim 30, wherein the parameter comprises at least one of:
a requested number of fixes;
a requested time between the fixes; and
a requested quality of position.

32. A mobile terminal according to claim 29, wherein the position data comprises at least one of:
a determination of the location of the mobile terminal;
a time since the location of the mobile terminal was determined; and
a status message including a reason for termination of the positioning event.

33. A mobile terminal according to claim 29, wherein the positioning event comprises obtaining the position data in response to the mobile terminal conducting a location session with a network.

34. A mobile terminal according to claim 29, wherein the positioning event comprises obtaining the position data independent of a network.
